(19) United States
(12) Patent Application Publication
(10) Pub. No.: US 2022/0191095 A1
(43) Pub. Date: Jun. 16, 2022

(54) PORT UNAVAILABILITY REMEDIATION SYSTEM

(71) Applicant: Dell Products L.P., Round Rock, TX (US)

(72) Inventors: Sudharsan Dhamal Gopalarathnam, Redmond, WA (US); Vinoth Kumar Arumugam, Fremont, CA (US)

(21) Appl. No.: 17/118,959

(22) Filed: Dec. 11, 2020

(51) Int. Cl. H04L 12/24

(52) U.S. Cl. CPC H04L 41/0816; H04L 41/0654

(57) ABSTRACT

A port unavailability remediation system includes a management device and a networking device including a plurality of physical ports. Following the unavailability of a first physical port that is included in the plurality of physical ports and that is linked to a first port identifier, the networking device receives a port identifier link change request from the management device that requests the linking of the first port identifier to a second physical port that is included in the plurality of physical ports and, in response, links the first port identifier to the second physical port. Subsequent to linking the first port identifier to the second physical port, the networking device prevents modification of the second physical port.

### BACKGROUND

The present disclosure relates generally to information handling systems, and more particularly to remediating port unavailability in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as switch devices, router devices, and/or other networking devices known in the art, include a plurality of ports that are coupled to other devices (e.g., via cabling to server devices, other networking devices, etc.) in order to transmit data between those devices. In datacenters and/or other multi-networking device use-cases known in the art, different networking devices in the datacenter may have their ports connected to corresponding devices in the same configuration according to automation and management templates that allow for the automated configuration of those ports, as well as management operations, troubleshooting operations, and/or other operations known in the art. For example, a network administrator or other user may deploy switch devices in different racks in a datacenter such that the last four ports on each switch device are always connected to a corresponding router device (e.g., a spine router device) in a particular order, with the first port on each switch device connected to a corresponding first server device in its rack, the second port on each switch device connected to a corresponding second server device in its rack, and so on until all of the server devices in each rack are connected to a switch device(s) in that rack.

As will be appreciated by one of skill in the art in possession of the present disclosure, the port connections on each of the switch devices in the racks in the datacenter discussed above may be identical in order to automate the configuration of all similarly identified ports on each switch device. In other words, using the example provided above, the first port on each switch device in each rack may be automatically configured based on its connection to the corresponding first server device in that rack, the second port on each switch device in each rack may be automatically configured based on its connection to the corresponding second server device in that rack, and up to the nth port on each switch device in each rack may be automatically configured based on its connection to the corresponding nth server device in that rack, while the last four ports on each switch device in each rack may be automatically configured based on their connections to corresponding router device(s). As such, automated configuration of ports on the networking devices in a datacenter is enabled, and one of skill in the art in possession of the present disclosure will recognize that providing the identical port connections to switch devices in different racks as described above also simplifies management and troubleshooting (e.g., if the first server device in a rack is unavailable, a user will know that first server device is connected to the first port on the switch device(s) in that rack, and can quickly troubleshoot that connection to determine if that is the cause of the first server unavailability).

However, ports on a networking device may become unavailable due to, for example, a port hardware failure (e.g., a failure of a physical (PHY) device included in the port) and/or other port unavailability issues that would be apparent to one of skill in the art in possession of the present disclosure. Furthermore, even though that networking device will typically include one or more ports that are both unused and available, network administrators or other users will often replace that networking device rather than switch the connection of the unavailable port to an port that is unused and available, as the use of that unused available port will not comply with the automation and management templates discussed above, and will cause issues with the automation, management, and troubleshooting operations detailed above. The replacement of a networking device due to an unavailable port when that networking device includes unused available ports results in downtime in the datacenter, as well as costs to the networking device vendor.

Accordingly, it would be desirable to provide a port unavailability remediation system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a physical port/port identifier linking engine that is configured to: receive, from a management device following the unavailability of a first physical port that is coupled to the processing system and that is linked to a first port identifier, a first port identifier link change request that requests the linking of the first port identifier to a second physical port that is coupled to the processing system; link, in response to receiving the first port identifier link change request, the first port identifier to the second physical port; and prevent, subsequent to linking the first port identifier to the second physical port, modification of the second physical port.

### BRIEF DESCRIPTION OF THE DRAWINGS

FIG. 1 is a schematic view illustrating an embodiment of an Information Handling System (IHS).

FIG. 2 is a schematic view illustrating an embodiment of a networked system.

FIG. 3 is a schematic view illustrating an embodiment of a networking device that is included in the networked system of FIG. 2 and that may utilize the port unavailability remediation system of the present disclosure.

FIG. 4A is a flow chart illustrating an embodiment of a portion of a method for remediating port unavailability.

FIG. 4B is a flow chart illustrating an embodiment of a portion of the method for remediating port unavailability of FIG. 4A.

FIG. 5A is a schematic view illustrating an embodiment of the networking device of FIG. 3 operating during the method of FIG. 4.

FIG. 5B is a schematic view illustrating an embodiment of the networking device of FIG. 3 operating during the method of FIG. 4.

FIG. 5C is a schematic view illustrating an embodiment of the networked system of FIG. 2 operating during the method of FIG. 4.

FIG. 5D is a schematic view illustrating an embodiment of the networking device of FIG. 3 operating during the method of FIG. 4.

FIG. 5E is a schematic view illustrating an embodiment of the networking device of FIG. 3 operating during the method of FIG. 4.

FIG. 5F is a schematic view illustrating an embodiment of the networking device of FIG. 3 operating during the method of FIG. 4.

FIG. 5G is a schematic view illustrating an embodiment of the networking device of FIG. 3 operating during the method of FIG. 4.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

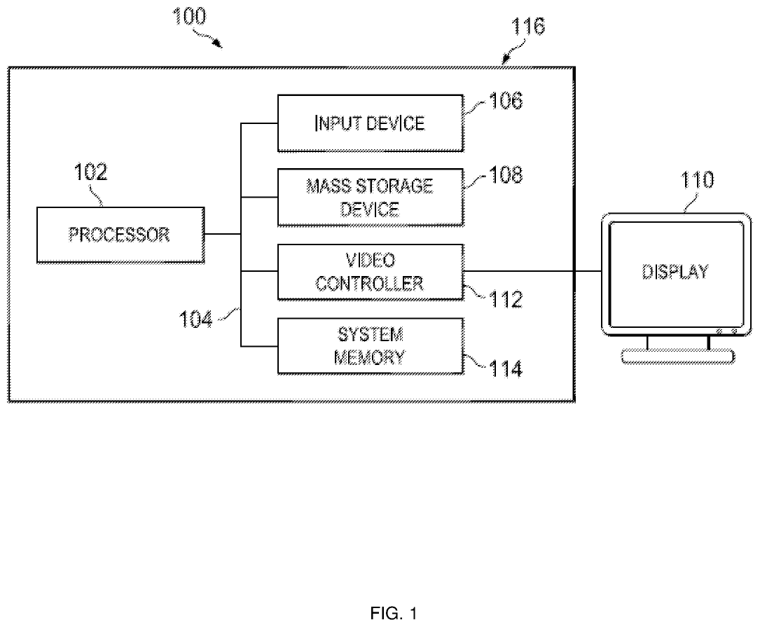

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

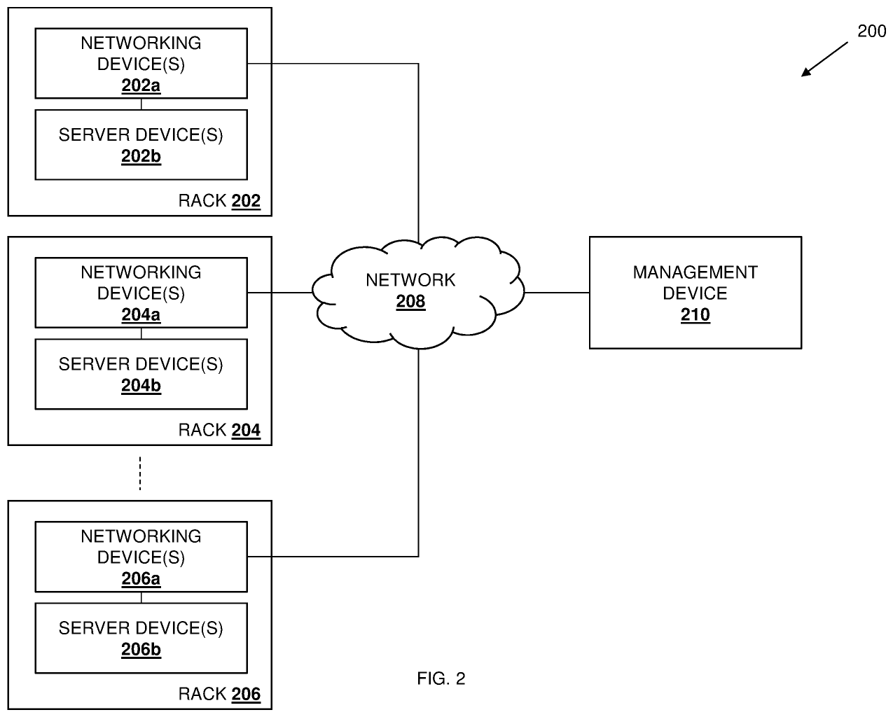

Referring now to FIG. 2, an embodiment of a networked system 200 is illustrated. In the illustrated embodiment, the networked system 200 includes a plurality of racks 202, 204, and up to 206, with each rack including one or more networking devices coupled to one or more server devices. For example, in the illustrated embodiment, the rack 202 includes networking device(s) 202a coupled to server device(s) 202b, the rack 204 includes networking device(s) 204a coupled to server device(s) 204b, and the rack 206 includes networking device(s) 206a coupled to server device(s) 206b. In an embodiment, any of the networking devices 202a, 204a, and up to 206a may be provided by the IHS 100 discussed above with reference to FIG. 1, and/or may include some or all of the components of the IHS 100, and in the specific examples below are illustrated and described as being provided by switch devices. However, while illustrated and discussed as being provided by switch devices, one of skill in the art in possession of the present disclosure will recognize that networking device provided in the networked system 200 may include other networking devices (e.g., router devices) that may be configured to operate similarly as the networking device 202a-206a discussed below. In an embodiment, any of the server devices 202b, 204b, and up to 206b may be provided by the IHS 100 discussed above with reference to FIG. 1, and/or may include some or all of the components of the IHS 100. However, while illustrated and discussed as being provided by server devices one of skill in the art in possession of the present disclosure will recognize that the server devices 202a-206b in the networked system 200 in FIG. 2 may be replaced with other computing devices that may be configured to operate similarly as the server device 202b-206b discussed below.

In the illustrated embodiment, the networking devices 202a, 204a, and up to 206a are each coupled to a network 208 that may be provided by a Local Area Network (LAN), the Internet, combinations thereof, and/or other networks that would be apparent to one of skill in the art in possession of the present disclosure. For example, the network 208 may be provided by one or more of the router devices discussed below, as well as variety of other network-providing devices known in the art. The illustrated embodiment also includes a management device 210 that is coupled via the network 208 to each of the networking devices 202b-206b. In an embodiment, the management device 210 may be provided by the IHS 100 discussed above with reference to FIG. 1, and/or may include some or all of the components of the IHS 100, and in the specific examples below is illustrated and described as being provided by a desktop computing device, a laptop/notebook computing device, a tablet computing device, a mobile phone, and/or other management devices that would be apparent to one of skill in the art in possession of the present disclosure. However, as discussed in further detail below, the management device 210 may instead be directly coupled to any of the networking devices 202a-206a while remaining within the scope of the present disclosure as well. Furthermore, while a specific networked system 200 has been illustrated and described, one of skill in the art in possession of the present disclosure will recognize that the networked system 200 of the present disclosure may include a variety of components and component configurations while remaining within the scope of the present disclosure as well.

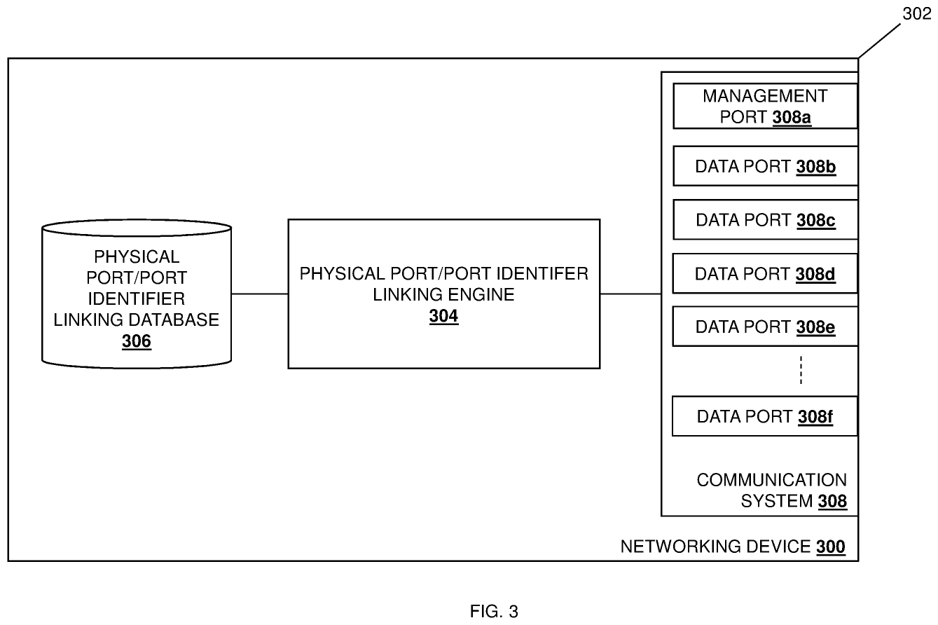

Referring now to FIG. 3, an embodiment of a networking device 300 is illustrated that may provide any or all of the networking devices 202a-206a discussed above with reference to FIG. 2. As such, the networking device 300 may be provided by the IHS 100 discussed above with reference to FIG. 1 and/or may include some or all of the components of the IHS 100, and in specific examples is discussed below as being provided by a switch device. However, while illustrated and discussed as being provided by a switch device, one of skill in the art in possession of the present disclosure will recognize that the functionality of the networking device 300 discussed below may be provided by other networking devices (e.g., router devices) that are configured to operate similarly as the networking device 300 discussed below. In the illustrated embodiment, the networking device 300 includes a chassis 302 that houses the components of the networking device 300, only some of which are illustrated below. For example, the chassis 302 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a physical port/port identifier linking engine 304 that is configured to perform the functionality of the physical port/port identifier linking engines and/or networking devices discussed below.

The chassis 302 may also house a storage system (not illustrated, but which may include the storage 108 discussed above with reference to FIG. 1) that is coupled to the physical port/port identifier linking engine 304 (e.g., via a coupling between the storage system and the processing system) and that includes a physical port/port identifier linking database 306 that is configured to store any of the information utilized by the physical port/port identifier linking engine 304 discussed below. The chassis 302 may also house a communication system 308 that is coupled to the physical port/port identifier linking engine 304 (e.g., via a coupling between the communication system 308 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. In the illustrated embodiment, the communication system 308 includes a management port 308a that is configured to couple to the management device 210 discussed above with reference to FIG. 2 (e.g., via the network 208 as illustrated, directly, etc.), and a plurality of data ports 308b, 308c, 308d, 308e, and up to 308f that are configured to connect to the server devices 202b-206b, as well as the router device(s) that provide the network 208 discussed above with reference to FIG. 2. However, while a specific networking device 300 has been illustrated, one of skill in the art in possession of the present disclosure will recognize that networking devices (or other devices operating according to the teachings of the present disclosure in a manner similar to that described below for the networking device 300) may include a variety of components and/or component configurations for providing conventional networking device functionality, as well as the functionality discussed below, while remaining within the scope of the present disclosure as well.

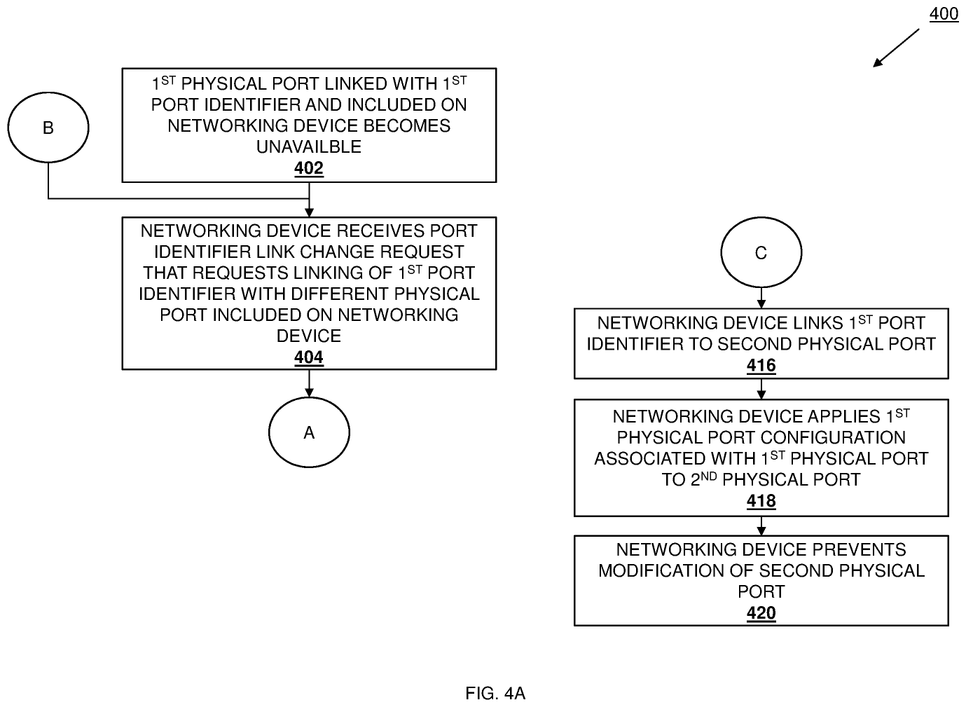

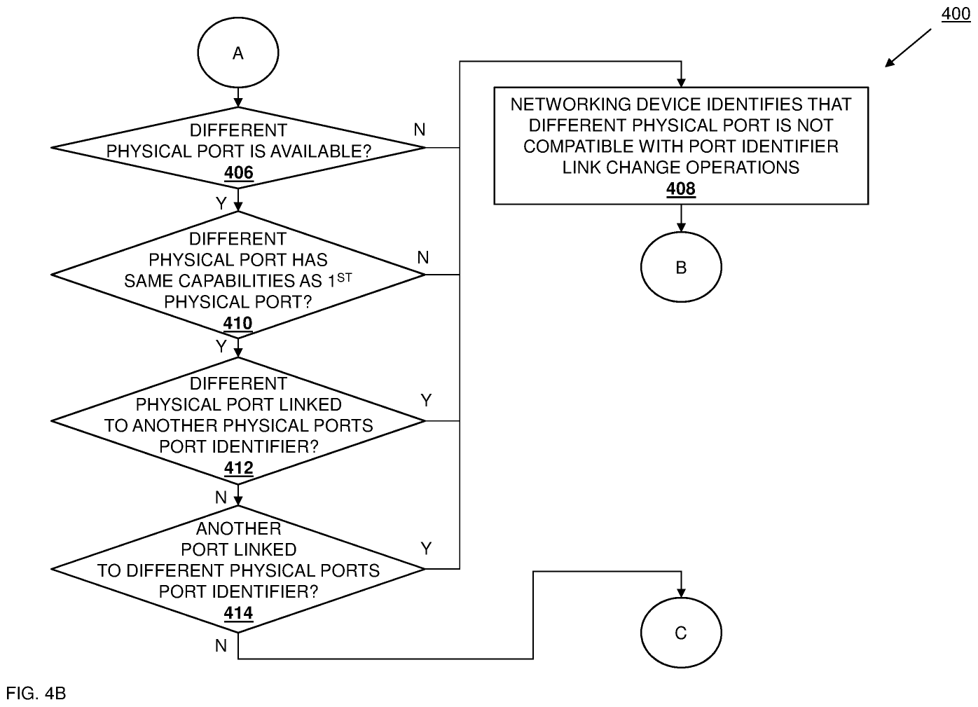

Referring now to FIG. 4, an embodiment of a method 400 for remediating port unavailability is illustrated. As discussed below, the systems and methods of the present disclosure provide, when a first physical port on a networking device becomes unavailable, for the linking of a port identifier which was associated with that first physical port (when it became unavailable) to a second physical port that is available and unused, along with preventing the modification of that second physical port following its linking to that port identifier. For example, the port unavailability remediation system of the present disclosure may include a management device and a networking device including a plurality of physical ports. Following the unavailability of a first physical port that is included in the plurality of physical ports and that is linked to a first port identifier, the networking device receives a port identifier link change request from the management device that requests the linking of the first port identifier to a second physical port that is included in the plurality of physical ports and, in response, links the first port identifier to the second physical port. Subsequent to linking the first port identifier to the second physical port, the networking device prevents modification of the second physical port. As such, an available and unused physical port on a networking device may be used in place of a physical port on that networking device that become unavailable without the negative effects to automation, management, troubleshooting, and/or other operations that occur in conventional networking devices.

The method 400 begins at block 402 where a first physical port that is linked with a first port identifier and that is included on a networking device becomes unavailable. In an embodiment, during or prior to the method 400, the networking devices 202a/300, 204a/300, and 206a/300 discussed above with reference to FIGS. 2 and 3 may have their data ports 308b-308f connected to router device(s) that provide the network 208, as well as their respective server devices 202b, 204b, and 206b. Furthermore, as discussed above, the port connections on each of the networking devices 202a-206a in the racks 202-206, respectively, may be identical in order to automate the configuration of all similarly identified ports on each networking device. In a specific example, the data port 308b on each networking device 202a-206a in each rack 202-206, respectively, may be connected (e.g., via a cable, not illustrated) to a corresponding first of the server devices 202b-206b in its rack 202-206 (e.g., a first server device provided in a first physical location that is common across the racks 202-206); the data port 308c on each networking device 202a-206a in each rack 202-206, respectively, may be connected (e.g., via a cable, not illustrated) to a corresponding second of the server devices 202b-206b in its rack 202-206 (e.g., a second server device provided in a second physical location that is common across the racks 202-206); and so on until each of the server devices 202b-206b in common physical locations in the racks 202-206, respectively, are connected (e.g., via a cable, not illustrated) to similar ports on the networking device 202a-206a, respectively, in those racks 202-206.

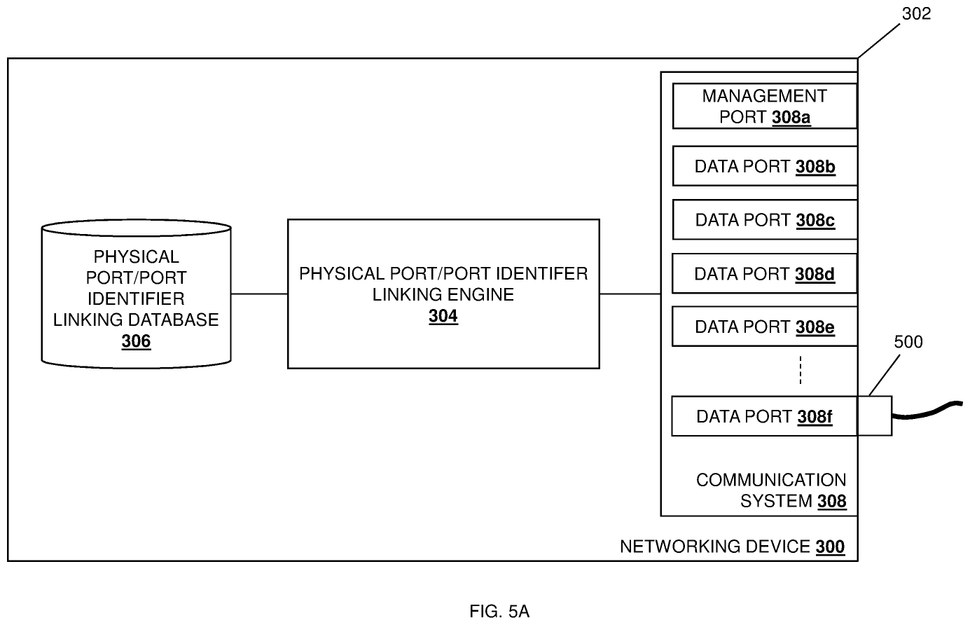

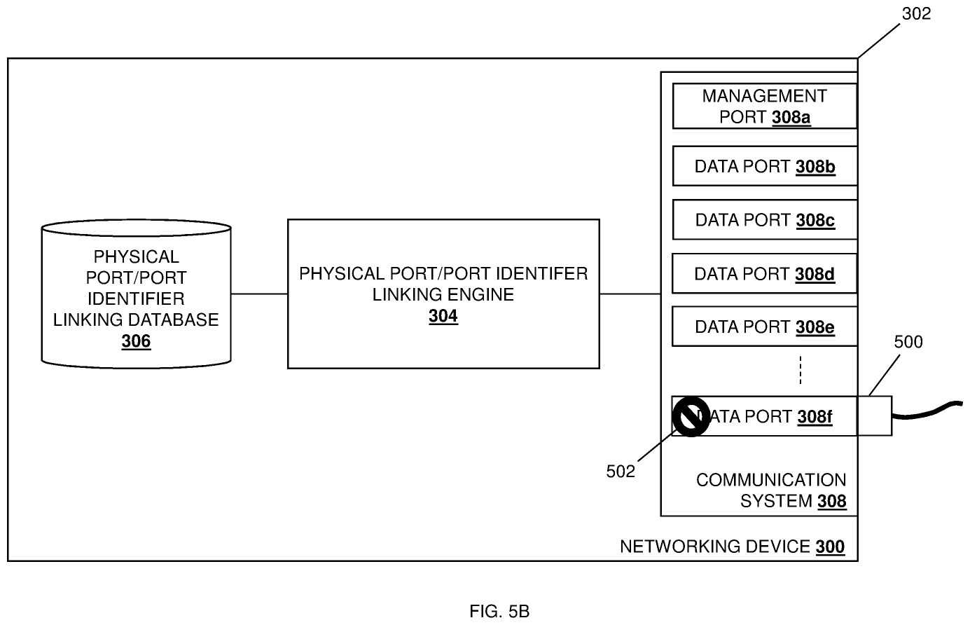

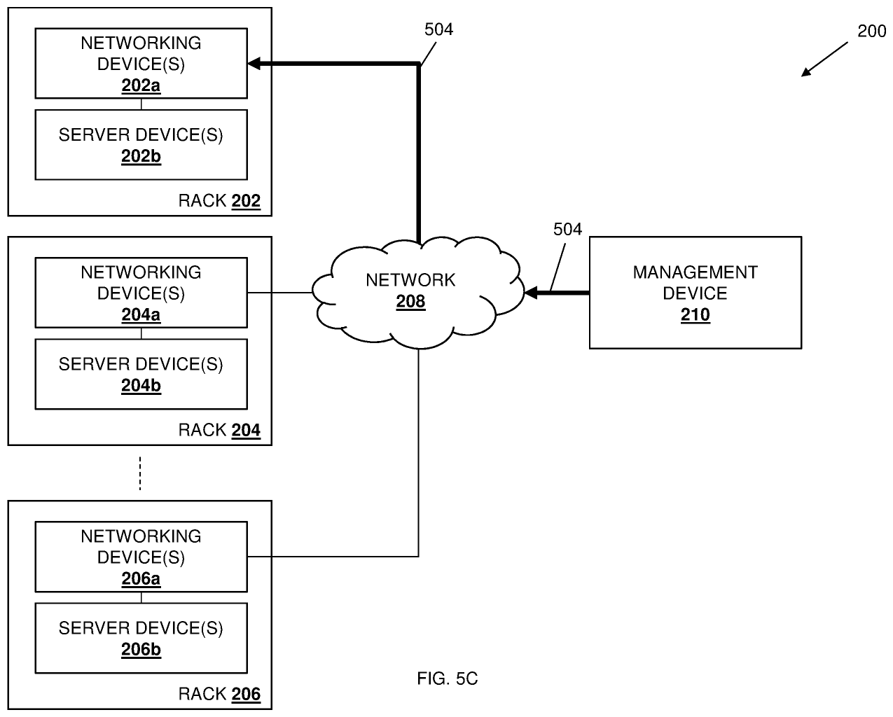

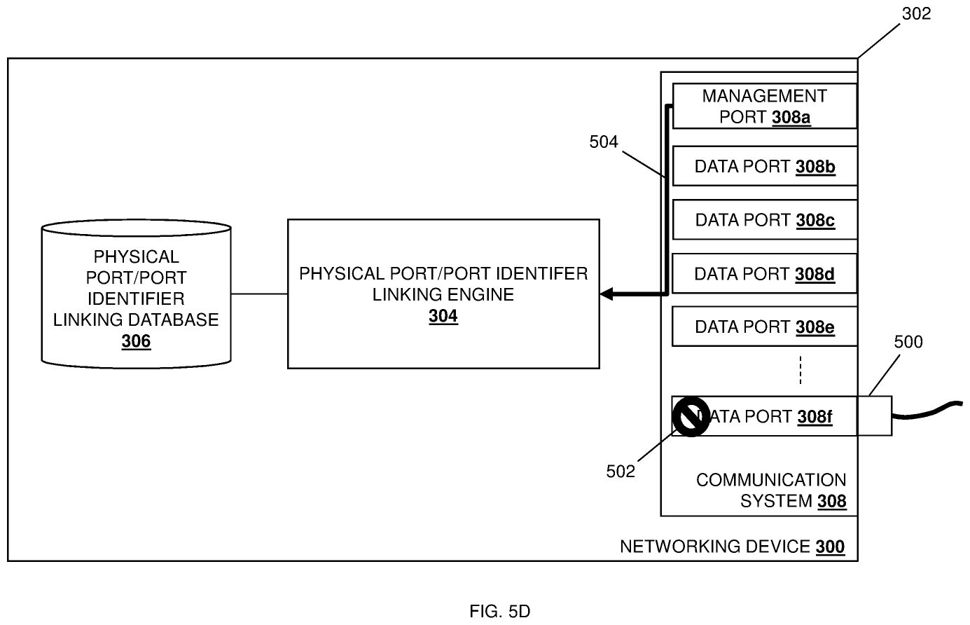

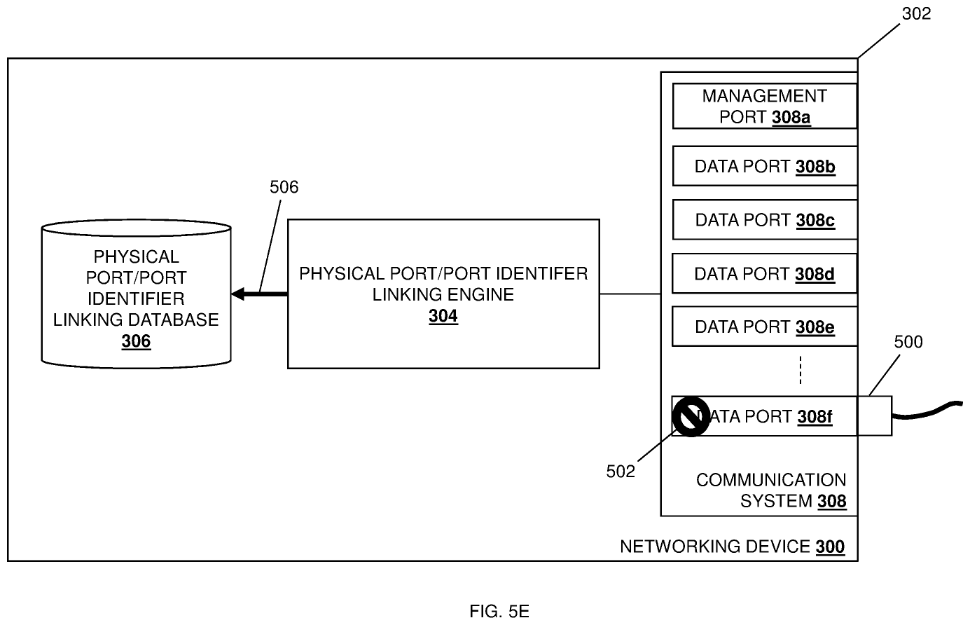

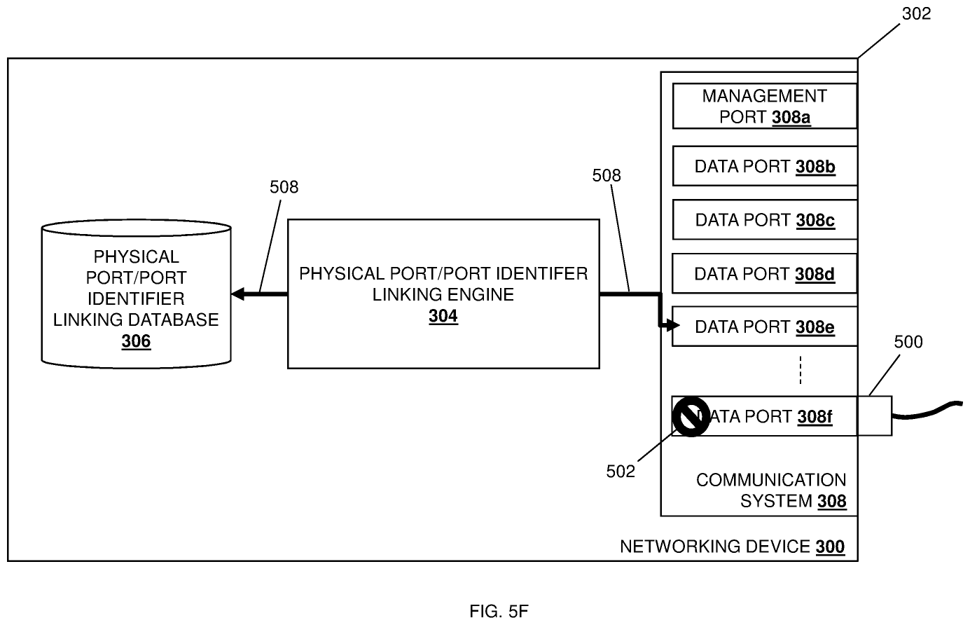

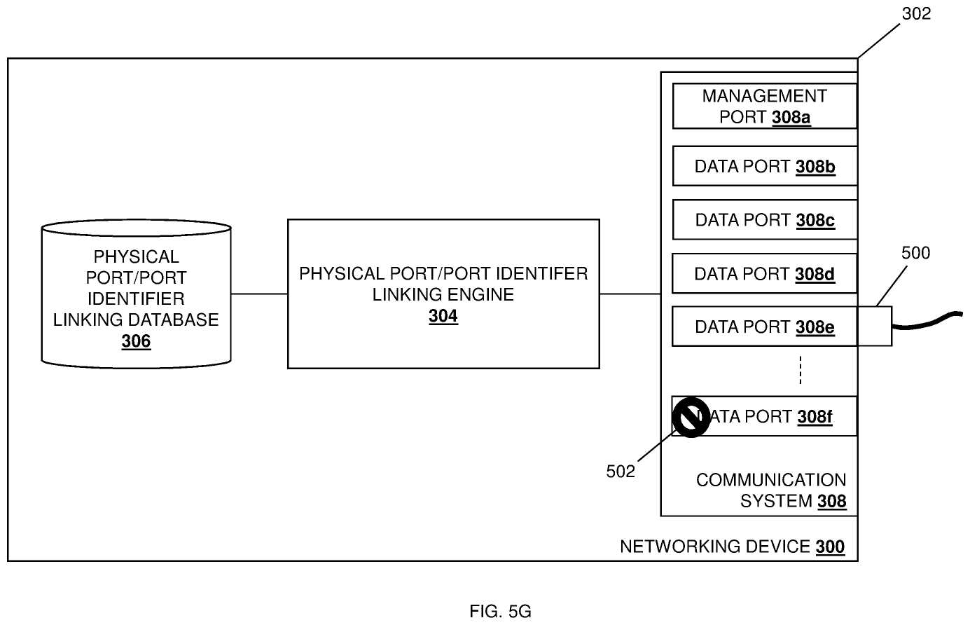

Continuing with the specific example provided above, one or more data ports on each of the networking devices 202a-206a may be connected to router device(s) that provide the network 208, and the examples illustrated and discussed below provide the data port 308f on each networking device 202a-206a in each rack 202-206, respectively, connected via a cable (e.g., the cable 500 in the illustrated embodiment) to a corresponding router device that provides the network 208, as illustrated in FIG. 5A. However, while the networking device(s) are illustrated as only including a single connection to corresponding router device(s) that provide the network 208, one of skill in the art in possession of the present disclosure will appreciate that the networking devices 202a-206a in each rack 202-206, respectively, may include multiple connections (via multiple data ports) to corresponding router device(s) that provide the network 208. As discussed above, the identical port connections provided for each of the networking device allows for automated configuration of the data ports on the networking devices, and also simplifies management and troubleshooting (e.g., if a first server device in a rack is unavailable, a user will know that first server device is connected to the data port 308b on the networking device(s) in that rack, and can quickly troubleshoot that connection to determine if that is the cause of the first server unavailability). In the examples below, a data port unavailability is described as occurring in a data port on a networking device 202a included in the rack 202, but one of skill in the art in possession of the present disclosure will appreciate that data ports may become unavailable in any networking device 202a-206a in any of the racks 202-206, respectively, and that the port unavailability remediation operations described below may be performed to remediate those port unavailabilities while remaining within the scope of the present disclosure as well.

With reference to FIG. 5B, in an embodiment of block 402, the data port 308a on the networking device 202a in the rack 202 that is coupled to a router device that provides the network 208 may become unavailable (e.g., as illustrated by element 502 in FIG. 5B). For example, the data port 308a on the networking device 202a in the rack 202 may experience a hardware failure such as the failure of a physical (PHY) device included in the data port 308a, which one of skill in the art in possession of the present disclosure will appreciate will render that data port 308a unavailable to transmit data to and from the networking device 202a in the rack 202. However, while a specific hardware failure that causes the data port 308b to become unavailable has been described, one of skill in the art in possession of the present disclosure will appreciate that data ports may become unavailable due to a variety of issues, any of which may be remedied as discussed below while remaining within the scope of the present disclosure. For example, a data port on a networking device may be considered “unavailable” in in the event that data port experiences link failures above a link failure threshold, Cyclic Redundancy Check (CRC) errors above a CRC error threshold, packet drops above a packet drop threshold, and/or based on any of a variety of other unavailability criteria that would be apparent to one of skill in the art in possession of the present disclosure.

The method 400 then proceeds to block 404 where the networking device receives a port identifier link change request that requests linking of the first port identifier with a different physical port included on the networking device. In an embodiment, at block 404 and in response to the unavailability of the data port 308a on the networking device 202a in the rack 202, a networking administrator or other user may identify that data port unavailability. At block 404 and in response to identifying the unavailability of the data port 308a on the networking device 202a in the rack 202, the networking administrator or other user may use a management device to transmit a port identifier link change request to the networking device 202a in the rack 202. As illustrated in FIGS. 5C and 5D, in some examples, the networking administrator or other user may use the management device 210 that is coupled via the network 208 to the management port 308a on networking device 202a/300 in the rack 202 to perform port identifier link change request transmission operations 504 in order to transmit a port identifier link change request to the networking device 202a/300 in the rack 202. As such, at block 404, the physical port/port identifier linking engine 304 in the networking device 202a/300 may receive the port identifier link change request via the management port 308a in its communication system 308.

However, in other examples, the networking administrator or other user may connect a management device directly to the management port 308a on networking device 202a/300 in the rack 202 in order to transmit a port identifier link change request to the networking device 202a/300 in the rack 202. Furthermore, while several specific examples are provided, one of skill in the art in possession of the present disclosure will appreciate that the port identifier link change request of the present disclosure may be provided to networking devices in a variety of manners that will fall within the scope of the present disclosure as well.

In a specific example, the networking administrator or other user may utilize a Command Link Interface (CLI) available in the networking device 202a (e.g., via the physical port/port identifier linking engine 304 in the networking device 202a/300) in order to transmit a port identifier link change request to the networking device 202a that requests the linking of a first port identifier for the data port 308f on the networking device 202a that became unavailable to the data port 308e on the networking device 308e. For example, the data port 308f on the networking device 202a/300 may be associated with a port identifier “Ethernet 1/1/30”, and the data port 308e may be associated with a port identifier “Ethernet 1/1/29”, and one of skill in the art in possession of the present disclosure will appreciate how the following CLI command may provide the port identifier link change request of the present disclosure in such an example:

NetworkingDevice202a (config)#link port Ethernet1/1/30 to Ethernet 1/1/29

However, while a specific example of a CLI command that provides the port identifier link change request of the present disclosure has been provided, one of skill in the art in possession of the present disclosure will appreciate how a variety of CLI commands may be utilized to provide the request to link a first port identifier for an unavailable data port on a networking device to a different port on that networking device while remaining within the scope of the present disclosure as well. Furthermore, while the use of a CLI to provide the port identifier link change request is described, one of skill in the art in possession of the present disclosure will appreciate that other techniques (e.g., a Graphical User Interface (GUI), etc.) may be utilized to provide the port identifier link change request while remaining within the scope of the present disclosure as well.

The specific example provided herein discusses the network administrator or other user identifying a particular data port (e.g., the data port 308e on the networking device 202a) as part of the port identifier link change request, and the method 400 continues below to determine whether that particular data port is appropriate for port identifier link change operations. However, one of skill in the art in possession of the present disclosure will appreciate that the method 400 may instead operate to identify particular data port(s) that is appropriate for the port identifier link change operations discussed below, and then identify those particular data port(s) to the network administrator or other user. For example, the port identifier link change request transmitted by the network administrator or other user and received by the networking device 202a may identify the data port that became unavailable (e.g., the data port 308f on the networking device 202a/300 in the examples below), and may cause the physical port/port identifier linking engine 304 in the networking device 202a/300 to perform the operations discussed below with reference to decision blocks 406, 410, 412, and 414 in order to determine particular data port(s) that are appropriate for port identifier link change operations, and then identify those particular data port(s) to the network administrator or other user.

The method 400 then proceeds to decision block 406 where it is determined whether the different physical port is available. In an embodiment, at decision block 406 and in response to the network administrator or other user identifying the data port 308e on the networking device 202a/300 (i.e., a “different” data port that is different than the data port 308f on the networking device 202a/300 that is unavailable) in the port identifier link change request at block 404, the physical port/port identifier linking engine 304 in the networking device 202a/300 may operate to determine whether the data port 308e on the networking device 202a/300 is unavailable. For example, at decision block 406, the physical port/port identifier linking engine 304 in the networking device 202a/300 may determine whether any configurations have been applied to the data port 308e on the networking device 202a/300, and one of skill in the art in possession of the present disclosure will appreciate that a lack of configurations applied to a data port indicates that data port is currently unused and available for the port identifier link change operations discussed below. In other embodiments in which the physical port/port identifier linking engine 304 in the networking device 202a/300 determines data port(s) that are appropriate for port identifier link change operations, the physical port/port identifier linking engine 304 in the networking device 202a/300 may identify which data ports on the networking device 202a/300 do not include any configurations. However, while a specific technique for determining data port availability has been described, one of skill in the art in possession of the present disclosure will appreciate that data port availability may be determined using other techniques while remaining within the scope of the present disclosure as well.

If, at decision block 406, it is determined that the different physical port is not available, the method 400 proceeds to block 408 where the networking device identifies that the different physical port is not compatible with port identifier link change operations. In an embodiment, at block 408 and in response to determining that the data port 308e on the networking device 202a identified by the network administrator or other user in the port identifier link change request is unavailable at decision block 406, the physical port/port identifier linking engine 304 in the networking device 202a/300 may identify to the network administrator or other user that the data port 308e on the networking device 202a is not compatible with port identifier link change operations. In some embodiments, the port identifier link change operations of the present disclosure may only be performed using a data port that is not currently being used, and thus the determination that the data port 308e on the networking device 202a/300 has a configuration applied and thus is currently being used (or based on the results of other data port unavailability determination techniques) will render that data port 308a unavailable and incompatible with port identifier link change operations. As such, in a specific example, the physical port/port identifier linking engine 304 in the networking device 202a/300 may provide (e.g., via the CLI discussed above, a GUI, etc.) an identification for display on the management device 210 that the data port 308e is incompatible with port identifier link change operations. The method 400 may then return to block 404. As such, the method 400 may loop such that the network administrator or other user may provide port identifier link change requests until a different data port that is available is identified by that network administrator or other user.

If at decision block 406, it is determined that the different physical port is available, the method 400 proceeds to decision block 410 where it is determined whether the different physical port has the same capabilities as the first physical port. In an embodiment, at decision block 410 and in response to determining that the data port 308e on the networking device 202a identified by the network administrator or other user in the port identifier link change request is available at decision block 406, the physical port/port identifier linking engine 304 in the networking device 202a/300 may operate to determine whether the data port 308e on the networking device 202a/300 has the same capabilities as the data port 308f on the networking device 202a/300. For example, at decision block 410, the physical port/port identifier linking engine 304 in the networking device 202a/300 may determine whether the speed and/or other capabilities of the data port 308e on the networking device 202a/300 are the same as the data port 308f on the networking device 202a/300.

For example, one of skill in the art in possession of the present disclosure will appreciate that the data ports 308e and 308f on the networking device 202a/300 may require matching capabilities (e.g., the same speed) in order to perform the port identifier link change operations discussed below (e.g., performing the port identifier link change operations discussed below with data ports having different capabilities may cause issues with the port on the other end of the link, i.e., the port on the router device that provides the network 208 in this example). In other embodiments in which the physical port/port identifier linking engine 304 in the networking device 202a/300 determines data port(s) that are appropriate for port identifier link change operations, the physical port/port identifier linking engine 304 in the networking device 202a/300 may identify which data ports on the networking device 202a/300 include the same capabilities as the data port that became unavailable. However, while a specific data port capability (e.g., speed) has been described, one of skill in the art in possession of the present disclosure will appreciate that a variety of matching data port capabilities may be identified while remaining within the scope of the present disclosure as well. Furthermore, one of skill in the art in possession of the present disclosure will appreciate that, in some embodiments, only a subset of the available capabilities of data ports may be required to match in order to perform the port identifier link change operations discussed below while remaining within the scope of the present disclosure as well.

If, at decision block 410, it is determined that the different physical port does not have the same capabilities as the first physical port, the method 400 proceeds to block 408 where the networking device identifies that the different physical port is not compatible with port identifier link change operations. In an embodiment, at block 408 and in response to determining that the data port 308e on the networking device 202a identified by the network administrator or other user in the port identifier link change request does not include the same capabilities as the data port 308f on the networking device 202a/300 at decision block 410, the physical port/port identifier linking engine 304 in the networking device 202a/300 may identify to the network administrator or other user that the data port 308e on the networking device 202a is not compatible with port identifier link change operations. In some embodiments, the port identifier link change operations of the present disclosure may only be performed using a data port that has the same capabilities as the data port that became unavailable, and thus the determination that the data port 308e on the networking device 202a has different capabilities than the data port 308f on the networking device 202a/300 will render that data port 308a incompatible with port identifier link change operations. As such, in a specific example, the physical port/port identifier linking engine 304 in the networking device 202a/300 may provide (e.g., via the CLI discussed above, a GUI, etc.) an identification for display on the management device 210 that the data port 308e is incompatible with port identifier link change operations. The method 400 may then return to block 404. As such, the method 400 may loop such that the network administrator or other user may provide port identifier link change requests until a different data port that is available and that includes the same capabilities as the data port that became unavailable is identified by that network administrator or other user.

If at decision block 412, it is determined that the different physical port has the same capabilities as the first physical port, the method 400 proceeds to decision block 412 where it is determined whether the different physical port is linked to a port identifier for another physical port. In an embodiment, at decision block 412 and in response to determining that the data port 308e on the networking device 202a identified by the network administrator or other user in the port identifier link change request has the same capabilities as the data port that became unavailable at decision block 410, the physical port/port identifier linking engine 304 in the networking device 202a/300 may operate to determine whether the data port 308e on the networking device 202a/300 is linked to a port identifier for another data port on the networking device 202a/300. For example, with reference to FIG. 5E, the physical port/port identifier linking engine 304 in the networking device 202a/300 may perform physical port/port identifier linking database access operations 506 to determine whether the data port 308e on the networking device 202a/300 is linked to a port identifier for another data port on the networking device 202a/300. In other embodiments in which the physical port/port identifier linking engine 304 in the networking device 202a/300 determines data port(s) that are appropriate for port identifier link change operations, the physical port/port identifier linking engine 304 in the networking device 202a/300 may identify which data ports on the networking device are not linked to a port identifier for another data port on the networking device 202a/300.

Using the specific example provided above, the data port 308e on the networking device 202a/300 may initially be associated with a port identifier “Ethernet 1/1/29”, and the port identifier link change request received at block 404 may request the association of the data port 308e on the networking device 202a/300 with the port identifier “Ethernet 1/1/30” that was initially associated with the data port 308f on the networking device 202a/300 that became unavailable at block 402. However, during a previous performance of the method 400, the port link change operations of the present disclosure may have been performed on the data port 308e on the networking device 202a/300 in order to associate that data port 308e on the networking device with a port identifier “Ethernet 1/1/31” of another data port on the networking device 202a/300 that became unavailable, and decision block 412 may be performed to ensure that port link change operations are not performed again on the data port 308e on the networking device 202a/300 in such situations (i.e., an available physical port that is currently linked to a first port identifier for a first unavailable physical port will not be linked to a second port identifier for a second unavailable port).

If, at decision block 412, it is determined that the different physical port is linked to another physical ports port identifier, the method 400 proceeds to block 408 where the networking device identifies that the different physical port is not compatible with port identifier link change operations. In an embodiment, at block 408 and in response to determining that the data port 308e on the networking device 202a identified by the network administrator or other user in the port identifier link change request is linked to a port identifier for another data port on the networking device 202a/300 at decision block 412, the physical port/port identifier linking engine 304 in the networking device 202a/300 may identify to the network administrator or other user that the data port 308e on the networking device 202a is not compatible with port identifier link change operations (e.g., the networking device 202a may “block” the use of its data port 308e in port identifier link change operations). In some embodiments, the port identifier link change operations of the present disclosure may only be performed using a data port that is not currently linked to a port identifier that was initially associated with another data port, and thus the determination that the data port 308e on the networking device 202a is linked to a port identifier for another data port on the networking device 202a/300 will render that data port 308e incompatible with port identifier link change operations. As such, in a specific example, the physical port/port identifier linking engine 304 in the networking device 202a/300 may provide (e.g., via the CLI discussed above, a GUI, etc.) an identification for display on the management device 210 that the data port 308e is incompatible with port identifier link change operations. The method 400 may then return to block 404. As such, the method 400 may loop such that the network administrator or other user may provide port identifier link change requests until a different data port that is available, that includes the same capabilities as the data port that became unavailable, and that is not linked to a port identifier for another data port is identified by that network administrator or other user.

If at decision block 412, it is determined that the different physical port is not linked to a port identifier for another physical port, the method 400 proceeds to decision block 414 where it is determined whether another port is linked to a port identifier for the different physical port. In an embodiment, at decision block 414 and in response to determining that the data port 308e on the networking device 202a identified by the network administrator or other user in the port identifier link change request is not linked to a port identifier for another data port on the networking device 202a/300 at decision block 412, the physical port/port identifier linking engine 304 in the networking device 202a/300 may operate to determine whether another data port on the networking device 202a/300 is linked to a port identifier for the data port 308e on the networking device 202a/300. For example, with reference to FIG. 5E, the physical port/port identifier linking engine 304 in the networking device 202a/300 may perform the physical port/port identifier linking database access operations 506 to determine whether another data port on the networking device 202a/300 is linked to a port identifier for the data port 308e on the networking device 202a/300. In other embodiments in which the physical port/port identifier linking engine 304 in the networking device 202a/300 determines data port(s) that are appropriate for port identifier link change operations, the physical port/port identifier linking engine 304 in the networking device 202a/300 may identify which data ports on the networking device do not have their port identifiers linked to another data port on the networking device 202a/300.

Using the specific example provided above, the data port 308e on the networking device 202a/300 may initially be associated with a port identifier “Ethernet 1/1/29”, and the port identifier link change request received at block 404 may request the association of the data port 308e on the networking device 202a/300 with the port identifier “Ethernet 1/1/30” that is initially associated with the data port 308f on the networking device 202a/300 that became unavailable at block 402. However, during a previous performance of the method 400, the data port 308e on the networking device 202a/300 may have become unavailable, and the port link change operations of the present disclosure may have been performed in order to associate the port identifier “Ethernet 1/1/29” that was initially associated with the data port 308e on the networking device 202a/300 with another data port on the networking device 202a/300, and decision block 414 may be performed to ensure that port link change operations are not performed on the data port 308e on the networking device 202a/300 in such situations (i.e., a first unavailable physical port that has its first port identifier linked to an available data port will not be linked to a second port identifier for another unavailable data port).

If, at decision block 414, it is determined that another port is linked to a port identifier for the different physical port, the method 400 proceeds to block 408 where the networking device identifies that the different physical port is not compatible with port identifier link change operations. In an embodiment, at block 408 and in response to determining that another data port on the networking device 202a/300 is linked to a port identifier for the data port 308e on the networking device 202a identified by the network administrator or other user in the port identifier link change request at decision block 414, the physical port/port identifier linking engine 304 in the networking device 202a/300 may identify to the network administrator or other user that the data port 308e on the networking device 202a is not compatible with port identifier link change operations. In some embodiments, the port identifier link change operations of the present disclosure may only be performed using a data port that was not initially associated with port identifier that is currently associated with another data port, and thus the determination that another data port is linked to the port identifier that was initially associated with the data port 308e on the networking device 202a will render that data port 308a incompatible with port identifier link change operations. As such, in a specific example, the physical port/port identifier linking engine 304 in the networking device 202a/300 may provide (e.g., via the CLI discussed above, a GUI, etc.) an identification for display on the management device 210 that the data port 308e is incompatible with port identifier link change operations. The method 400 may then return to block 404. As such, the method 400 may loop such that the network administrator or other user may provide port identifier link change requests until a different data port that is available, that includes the same capabilities as the data port that became unavailable, that is not linked to a port identifier for another data port, and that does not have another data port linked to its port identifier, is identified by that network administrator or other user

If, at decision block 414, it is determined that another port is not linked to the port identifier for the different physical port, the method 400 proceeds to block 416 where the networking device links the first port identifier to the second physical port. With reference to FIG. 5F, in an embodiment of block 416 and in response to determining the data port 308e on the networking device 202a/300 identified by the network administrator or other user in the port identifier link change request is compatible with port identifier link change operations (e.g., based on the decision blocks 406, 410, 412, and 414 discussed above), the physical port/port identifier linking engine 304 in the networking device 202a/300 may perform port identifier link change operations 508 that may include, for example, linking a port identifier for the data port 308f on the networking device 202a/300 to the data port 308e on the networking device 202a/300. Continuing with the example provided above, the linking of the port identifier for the data port 308f on the networking device 202a/300 to the data port 308e on the networking device 202a/300 may include modifying data port information in the physical port/port identifier linking database 306 and/or in the data port 308e on the networking device 202a/300 in order to link the data port 308e on the networking device 202a/300 to the port identifier “Ethernet 1/1/30” that was initially associated with the data port 308f on the networking device 202a/300 that became unavailable at block 402. As will be appreciated by one of skill in the art in possession of the present disclosure, the port identifier link change operations 508 performed at block 416 may include the modification of any data port information in the physical port/port identifier linking database 306 and/or the data port 308e on the networking device 202a/300 that allows the port identifier “Ethernet 1/1/30” to be linked to the data port 308e on the networking device 202a/300. Thus, the port identifier link change request to link the data port 308e on the networking device 202a/300 identified by the network administrator or other user to the port identifier for the data port 308f on the networking device 202a/300 (e.g., the request to link the port identifier “Ethernet 1/1/30” to “Ethernet 1/1/29”) will cause the physical port/port identifier linking engine 304 in the networking device 202a/300 to identify the data port 308e on the networking device 202a/300 and link the port identifier “Ethernet 1/1/30” to that physical port.

The method 400 proceeds to block 418 where the networking device applies a first physical port configuration associated with the first physical port to the second physical port. In an embodiment, at block 418, the physical port/port identifier linking engine 304 in the networking device 202a/300 may continue to perform port identifier link change operations 508 that may include, for example, applying the one or more data port configurations that are associated with the data port 308f on the networking device 202a/300 to the data port 308e on the networking device 202a/300. As will be appreciated by one of skill in the art in possession of the present disclosure, the linking of the port identifier “Ethernet 1/1/30” (which was initially assigned to the data port 308f on the networking device 202a/300) to the data port 308e on the networking device 202a/300 may cause any data port configurations that were applied to the data port 308f on the networking device 202a/300 to be applied to the data port 308e on the networking device 202a/300.

The method 400 proceeds to block 420 where the networking device prevents modification of the second physical port. In an embodiment, at block 420, the physical port/port identifier linking engine 304 in the networking device 202a/300 may continue to perform port identifier link change operations 508 that may include, for example, preventing modifications of the port identifier “Ethernet 1/1/29” that was initially assigned to the data port 308e on the networking device 202a/300. For example, the prevention of modifications of the port identifier “Ethernet 1/1/29” that was initially assigned to the data port 308e on the networking device 202a/300 may be accomplished by blocking access by the user to the port identifier “Ethernet 1/1/29” for management operations.

As illustrated in FIG. 5G, prior to, as part of, or subsequent to the port identifier link change operations 508 discussed above, the network administrator or other user may disconnect the cable 500 from the data port 308f on the networking device 202a/300, and reconnect that cable 500 to the data port 308e on the networking device 202a/300. As will be appreciated by one of skill in the art in possession of the present disclosure, the connection of the cable 500 to the data port 308e on the networking device 202a/300 and the performance of the port identifier link change operations 508 will allow the data port 308e on the networking device 202a/300 to operate with the port identifier “Ethernet 1/1/30” that was previously associated with the data port 308f on the networking device 202a/300, which allows the automation operations discussed above to continue to be performed without any modification (i.e., as the data port 308e on the networking device 202a/300 appears to the automation system as the data port 308f on the networking device 202a/300 that was initially associated with the port identifier “Ethernet 1/1/30”).

Furthermore, one of skill in the art in possession of the present disclosure will recognize that the data port 308e on the networking device 202a/300 may then operate to receive (e.g., from the management device discussed above) any management/port identifier queries directed to the port identifier “Ethernet 1/1/30” that was previously associated with the data port 308f on the networking device 202a/300, and return or otherwise provide port information associated with the data port 308e on the networking device 202a/300 in response to those management queries. Further still, one of skill in the art in possession of the present disclosure will recognize that the data port 308e on the networking device 202a/300 may also operate to learn control information (e.g., Media Access Control (MAC) information, route information, etc.) received in control packet(s), and classify or otherwise associate that control information as having been learned on a data port with port identifier “Ethernet 1/1/30”.

However, in some embodiments, the actual physical identifier of any data port on the networking device 202a/300 (e.g., the port identifier initially assigned to that data port) may be available to the network administrator or other user. For example, the networking device 202a/300 may be configured to transmit a discovery communication that identifies the actual physical identifier for any data port on the network device. For example, the networking device 202a/300 may transmit a Link Layer Discovery Protocol (LLDP) communication including a specific Type-Length-Value (TLV) that identifies the port identifiers that were initially assigned to those the data ports 308a-308f on the networking device rather than the port identifiers that were subsequently linked to those data ports in response to the unavailability of another data port, and thus that would identify the data port 308e on the networking device 202a/300 by the port identifier “Ethernet 1/1/29” that was initially assigned to it, rather than the port identifier “Ethernet 1/1/30” that was linked to it during the method 400.

Furthermore, a network administrator or other user may utilize a management device (e.g., the management device 210 discussed above) to transmit a “show” command (e.g., a physical port/port identifier linking show command) to the networking device 202a/300 that causes the networking device 202a/300 to identify the data ports on that networking device and their linked port identifiers (and which would list the data port 308e on the networking device 202a/300 as linked to the port identifier “Ethernet 1/1/30” in the example above).

Thus, systems and methods have been described that provide, when a first physical port on a switch device fails, for the linking of the port identifier that is associated with that first physical port when it failed to a second physical port that is available and unused, along with preventing the modification of that second physical port following its linking to that port identifier. For example, the port unavailability remediation system of the present disclosure may include a management device and a switch device including a plurality of physical ports. Following the failure of a first physical port that is included in the plurality of physical ports and that is linked to a first port identifier, the switch device receives a port identifier link change request from the management device that requests the linking of the first port identifier to a second physical port that is included in the plurality of physical ports and, in response, links the first port identifier to the second physical port. Subsequent to linking the first port identifier to the second physical port, the switch device prevents modification of the second physical port. As such, available and unused physical ports on a switch device may be used in place of a physical ports on that networking device that fail without the negative effects to automation, management, troubleshooting, and/or other operations that occur in conventional switch devices.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A port unavailability remediation system, comprising:
a management device; and
a switch including a plurality of physical ports, wherein the switch is configured to:
receive, from the management device following the unavailability of a first physical port that is included in the plurality of physical ports and that is linked in a physical port/port identifier linking database to a first port identifier that was initially assigned to the first physical port based on a physical location of the first physical port on the switch to automate the configuration of the first physical port with a first port configuration, a port identifier link change request that requests to change the linking in the physical port/port identifier linking database of the first port identifier from the first physical port to a second physical port that is included in the plurality of physical ports;
link, in response to receiving the port identifier link change request, the first port identifier to the second physical port in the physical port/port identifier linking database to cause the first port configuration to be applied to the second physical port; and
prevent, in response to linking the first port identifier to the second physical port, modification of the second physical port.

2. The system of claim 1, wherein the switch is configured to:
determine, in response to receiving the port identifier link change request, that the second physical port has the same port capabilities as the first physical port; and
link, in response to determining that the second physical port has the same port capabilities as the first physical port, the first port identifier to a second physical port.

3. The system of claim 1, wherein the first port configuration configured the first physical port to operate with a first device that was physically connected to the first physical port, and wherein the first port configuration configures the second physical port to operate with the first device that is physically connected to the second physical port.

4. The system of claim 1, wherein the switch is configured to:
receive, from the management device subsequent to linking the first port identifier to the second physical port, a first port identifier query associated with the first port identifier; and
provide, to the management device in response to the first port identifier query, second physical port information associated with second physical port.

5. The system of claim 1, wherein the switch is configured to:
learn, on the second physical port, control information included in one or more control packets; and
associate the control information with the first port identifier.

6. The system of claim 1, wherein the switch is configured to:
receive, from the management device, a physical port/port identifier linking show command; and
identify, in response to the physical port/port identifier linking show command, the linking of the second physical port with the first port identifier.

7. An Information Handling System (IHS), comprising:
a processing system; and
a memory system that is coupled to the processing system and that includes instructions that, when executed by the processing system, cause the processing system to provide a physical port/port identifier linking engine that is configured to:
receive, from a management device following the unavailability of a first physical port that is coupled to the processing system and that is linked in a physical port/port identifier linking database to a first port identifier that was initially assigned to the first physical port based on a physical location of the first physical port to automate the configuration of the first physical port with a first port configuration, a first port identifier link change request that requests to change the linking in the physical port/port identifier linking database of the first port identifier from the first physical port to a second physical port that is coupled to the processing system;
link, in response to receiving the first port identifier link change request, the first port identifier to the second physical port in the physical port/port identifier linking database to cause the first port configuration to be applied to the second physical port; and
prevent, in response to linking the first port identifier to the second physical port, modification of the second physical port.

8. The IHS of claim 7, wherein the physical port/port identifier linking engine is configured to:
determine, in response to receiving the first port identifier link change request, that the second physical port has the same port capabilities as the first physical port; and
link, in response to determining that the second physical port has the same port capabilities as the first physical port, the first port identifier to a second physical port.

9. The IHS of claim 7, wherein the first port configuration configured the first physical port to operate with a first device that was physically connected to the first physical port, and wherein the first port configuration configures the second physical port to operate with the first device that is physically connected to the second physical port.

10. The IHS of claim 7, wherein the physical port/port identifier linking engine is configured to:
receive, from the management device subsequent to linking the first port identifier to the second physical port, a first port identifier query associated with the first port identifier; and
provide, to the management device in response to the first port identifier query, second physical port information associated with second physical port.

11. The IHS of claim 7, wherein the physical port/port identifier linking engine is configured to:
learn, on the second physical port, control information included in one or more control packets; and
associate the control information with the first port identifier.

12. The IHS of claim 7, wherein the physical port/port identifier linking engine is configured to:
receive, from the management device, a physical port/port identifier linking show command; and
identify, in response to the physical port/port identifier linking show command, the linking of the second physical port with the first port identifier.

13. The IHS of claim 7, wherein the physical port/port identifier linking engine is configured to:
receive, from the management device following the unavailability of a third physical port that is coupled to the processing system and that is linked in the physical port/port identifier linking database to a third port identifier, a second port identifier link change request that requests to change the linking in the physical port/port identifier linking database of the third port identifier from the third physical port to the second physical port;
determine, in response to receiving the second port identifier link change request, that the second physical port is linked to the first port identifier; and
prevent, in response to determining that the second physical port is linked to the first port identifier, linking of the third port identifier to the second physical port.

14. A method for remediating port unavailability, comprising:
receiving, by a networking device from a management device following the unavailability of a first physical port that is included on the networking device and that is linked in a physical port/port identifier linking database to a first port identifier that was initially assigned to the first physical port based on a physical location of the first physical port on the networking device to automate the configuration of the first physical port with a first port configuration, a first port identifier link change request that requests to change the linking in the physical port/port identifier linking database of the first port identifier from the first physical port to a second physical port that is included on the networking device;
linking, by the networking device in response to receiving the first port identifier link change request, the first port identifier to the second physical port in the physical port/port identifier linking database to cause the first port configuration to be applied to the second physical port; and
preventing, by the networking device in response to linking the first port identifier to the second physical port, modification of the second physical port.

15. The method of claim 14, further comprising:
determining, by the networking device in response to receiving the first port identifier link change request, that the second physical port has the same port capabilities as the first physical port; and
linking, by the networking device in response to determining that the second physical port has the same port capabilities as the first physical port, the first port identifier to a second physical port.

16. The method of claim 14, wherein the first port configuration configured the first physical port to operate with a first device that was physically connected to the first physical port, and wherein the first port configuration configures the second physical port to operate with the first device that is physically connected to the second physical port.

17. The method of claim 14, further comprising:
receiving, by the networking device from the management device subsequent to linking the first port identifier to the second physical port, a first port identifier query associated with the first port identifier; and
providing, by the networking device to the management device in response to the first port identifier query, second physical port information associated with second physical port.

18. The method of claim 14, further comprising:
learning, by the networking device on the second physical port, control information included in one or more control packets; and
associating, by the networking device, the control information with the first port identifier.

19. The method of claim 14, further comprising:
receiving, by the networking device from the management device, a physical port/port identifier linking show command; and
identifying, by the networking device in response to the physical port/port identifier linking show command, the linking of the second physical port with the first port identifier.

20. The method of claim 14, further comprising:
receiving, by the networking device from the management device following the unavailability of a third physical port that is included on the networking device and that is linked in the physical port/port identifier linking database to a third port identifier, a second port identifier link change request that requests to change the linking in the physical port/port identifier linking database of the third port identifier from the third physical port to the second physical port;
determining, by the networking device in response to receiving the second port identifier link change request, that the second physical port is linked to the first port identifier; and
preventing, by the networking device in response to determining that the second physical port is linked to the first port identifier, linking of the third port identifier to the second physical port.
